(19) United States
(12) Patent Application Publication
(10) Pub. No.: US 2025/0023350 A1
(43) Pub. Date: Jan. 16, 2025

(54) Methods and Systems for Determining Properties of Electrical Networks

(71) Applicant: AspenTech Corporation, Bedford, MA (US)

(72) Inventors: Ogbonnaya Bassey, South Croydon (GB); Yan Pan, Plymouth, MN (US); Boqi Xie, Chandler, AZ (US)

(21) Appl. No.: 18/771,369

(22) Filed: Jul. 12, 2024

Related U.S. Application Data
(60) Provisional application No. 63/513,204, filed on Jul. 12, 2023.

(51) Int. Cl. H02J 3/00

(52) U.S. Cl. CPC H02J 3/007; H02J 2203/10; H02J 2203/20

(57) ABSTRACT

Embodiments determine properties of electrical networks. An example embodiment creates, in memory, a representation of an electrical network as a plurality of nodes, where the plurality of nodes include a source node and multiple downstream nodes. Next, a measurement of voltage at a node of the multiple downstream nodes is obtained. In turn, the created representation and the obtained measurement of voltage are used to iteratively perform, until convergence, a power flow analysis of the electrical network to determine the properties of the electrical network. Iteratively performing the power flow analysis includes, for each iteration: (i) incrementally updating a value of a variable representing voltage of the source node based on the obtained measurement of voltage, and (ii) performing the power flow analysis using the variable with the updated value.

### RELATED APPLICATION

This application claims the benefit of U.S. Provisional Application No. 63/513,204, filed on Jul. 12, 2023. The entire teachings of the above application are incorporated herein by reference.

### BACKGROUND

Functionality exists for the computer-based analysis and control of electrical networks and systems. However, existing methods can be inaccurate.

### SUMMARY

Embodiments solve problems in existing solutions and provide improved methods and systems for electrical network and system analysis and control.

One such existing electrical network analysis method is distribution power flow (DPF). DPF involves solving for an electrical system's state variables (e.g., nodal voltages). In an example electrical system being analyzed with DPF, a slack node (i.e., source node, infinite node) provides a fixed voltage reference, i.e., node, from which the other nodal voltages are computed. This means that the accuracy of the resulting power flow solution depends to a significant extent on the accuracy of the slack node's voltage.

This typical solution setup (relying upon the voltage of the slack node) can become an issue if the specified slack node does not have a good quality nodal voltage measurement, i.e., voltage of the slack node cannot be accurately measured, or voltage of the slack node varies over time. A current approach is to use a statically configured voltage as the slack node's voltage. However, this static voltage does not accurately represent real-time voltage of the slack node as the voltage value changes with varying system conditions. The inaccuracy of slack node voltage leads to inaccurate DPF results. Eventually, advanced applications, like load restoration and volt-var control, which are based upon DPF, are impacted by these errors. In distribution systems, good voltage measurements commonly exist on transformer nodes or substation nodes, however, if these measured nodes are not the slack nodes, DPF is not able to use the measured nodes as the voltage reference due to the prevalent formulation and computation method of conventional power flow engines.

Embodiments solve the foregoing problems by using an adaptive feedback control-based approach to enable DPF computations to incorporate a voltage measurement from a non-slack node closer to the slack node. This allows solid voltage measurements even from non-slack nodes to be leveraged in the power flow calculation which in turn ensures accurate calculation results and system control.

An example embodiment uses an adaptive feedback control approach to vary the slack's nodal voltage during power flow iterations. In such an embodiment, a non-slack node close to the slack node provides a fixed voltage reference for the control mechanism. Herein, this non-slack node may be referred to as a pseudo slack node (or pseudo source node) because it does not have all the features of the conventional power flow slack bus (i.e., slack node). To continue, the embodiment, during each power flow iteration, computes an error signal by comparing calculated nodal voltage and measured nodal voltage of the pseudo slack node. This error signal is then fed through an adaptive controller to update the slack's nodal voltage used in the next iteration of the DPF. This process is repeated over and over until power flow convergence.

Another example embodiment is directed to a computer-implemented method (i.e., a method implemented by one or more processors) for determining properties of an electrical network. The method creates, in memory, a representation of the electrical network as a plurality of nodes, where the plurality of nodes includes a source node and multiple downstream nodes. In turn, a measurement of voltage at a node of the multiple downstream nodes is obtained. To continue, using the created representation and the obtained measurement of voltage, the method iteratively performs, until convergence, a power flow analysis of the electrical network to determine the properties of the electrical network. In such an embodiment, iteratively performing the power flow analysis includes, for each iteration: (i) incrementally updating a value of a voltage variable representing voltage of the source node based on the obtained measurement of voltage, and (ii) performing the power flow analysis using the variable with the updated value.

According to an embodiment, incrementally updating the value of the variable representing voltage of the source node includes, in a given iteration, calculating a given value of the variable, calculating an error value by determining a difference between the calculated given value of the variable and the obtained measurement of voltage at the node of the multiple downstream nodes, and updating the value of the variable using the error calculated. Such an embodiment may further include, responsive to the error value being approximately equal to zero, determining convergence is reached.

In another embodiment, incrementally updating the value of the variable representing voltage of the source node based on the obtained measurement of voltage includes, in a given iteration, determining an error signal based on the obtained measurement of voltage and a voltage at the node of the multiple downstream nodes determined by an iteration prior to the given iteration, processing the error signal with one or more functions to determine a given value of the variable, and setting the updated value of the variable to be the given value.

According to an embodiment, the source node is located in relatively close proximity within the electrical network to the node of the multiple downstream nodes from which the measurement of voltage is obtained.

In another embodiment, obtaining the measurement of voltage at the node of the multiple downstream nodes includes receiving the measurement from a voltage meter at the node of the multiple downstream nodes.

In an embodiment, incrementally updating the value of the variable representing voltage of the source node based on the obtained measurement of voltage includes, modifying the value of the voltage variable for the source node by adjusting a gain parameter of one or more functions.

In yet another embodiment, based on results of the performing the power flow analysis, operation of an element in the electrical network is controlled.

Another embodiment is directed to a system for determining properties of an electrical network. The system includes a processor and a memory with computer code instructions stored thereon. The processor and the memory, with the computer code instructions, are configured to cause the system to implement any embodiments or combination of embodiments described herein.

Yet another embodiment is directed to a computer program product for determining properties of an electrical network. The computer program product comprises a non-transitory computer readable medium with computer code instructions stored thereon. The computer code instructions, when executed by a processor, cause an apparatus associated with the processor to perform any embodiments or combination of embodiments described herein.

It is noted that embodiments of the method, system, and computer program product may be configured to implement any embodiments, or combination of embodiments, described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is an example schematic diagram of an electrical system that may be analyzed

and controlled using embodiments.

FIG. 2 is a flow chart of a method of determining properties of an electrical network, according to an embodiment.

FIGS. 3A and 3B are schematic illustrations of adaptive feedback control methods that may be implemented in embodiments.

FIGS. 4A-4C are graphs of pseudo source voltage determined by an embodiment implemented with a gain parameter of 1, versus iterations.

FIGS. 5A-5C are graphs of pseudo source voltage determined by an embodiment implemented with a gain parameter of 0.5, versus iterations

FIGS. 6A-6C are graphs of the pseudo source voltage determined by an embodiment implemented with a gain parameter of 1.8, versus iterations.

FIG. 7 is a flow diagram of a method for analyzing an electrical network while adjusting a controller constant according to an embodiment.

FIG. 8 depicts a computer network or similar digital processing environment in which embodiments of the present disclosure may be implemented.

FIG. 9 is a diagram of an example internal structure of a computer in the computer system of FIG. 8, according to an embodiment.

### DETAILED DESCRIPTION

A description of example embodiments follows.

As described hereinabove, when determining properties of electrical networks utilizing power flow analysis, accuracy of the resulting solution depends to a significant extent on the accuracy of the source voltage used for the simulation (i.e., distribution power flow analysis). In the real-world, the stated supply voltage being used for network analysis is not always a perfect reflection of the actual voltage supplied to the network. As such, existing methods which rely on the stated supply voltage, i.e., source voltage, often produce inaccurate results. Embodiments solve this problem by integrating an iterative control loop to accurately represent real-world voltage within the simulation. The iterative control loop calculates voltage for a node located within close proximity to the source voltage, i.e., slack node, and uses that voltage as a pseudo source voltage for a power flow analysis of the network. This improvement allows for a more accurate power flow analysis and electrical network control.

Embodiments allow for good voltage measurements even from non-slack nodes to be leveraged in power flow calculations. This provides more accurate results compared to using a statically configured or fixed voltage value as the voltage reference. In addition, in terms of the solution method, embodiments can solve the entire power flow as one calculation without breaking the system into two or more fragments to be solved individually. A setback of a solution that involves breaking the system into multiple fragments is that after solving a downstream fragment, a tedious difficult-to-generalize back calculation is required to solve an upstream fragment. The elegance of embodiments is that with minimal changes to existing power flow engines, one can realize a flexible slack bus whose voltage varies to match the pseudo slack node.

Previous methods of power flow analysis do not utilize a flexible slack node approach. One relevant result is the work by Chang et al. [1] which improved the backward/forward sweep (BFS) algorithm using the linear proportional principle to match substation voltage (considered as the slack node voltage) without matching non-slack node voltages. The Chang method is an improvement on the forward sweep step of the BFS algorithm rather than an effort to implement a flexible slack node whose voltage reference comes from a voltage measurement at a downstream non-slack node. More specifically, the work by Chang et al. calculates the ratio of the calculated source (slack bus) voltage obtained from the backward sweep to the specified (telemetered) source voltage and uses this ratio to adjust the downstream voltage in the forward sweep iteration. Chang's proposed method is limited to only radial systems with linear injection elements. On the other hand, embodiments can analyze electrical networks/systems with non-linear injection elements and non-radial systems, and embodiments use a novel adaptive feedback control mechanism to drive the error signal to zero.

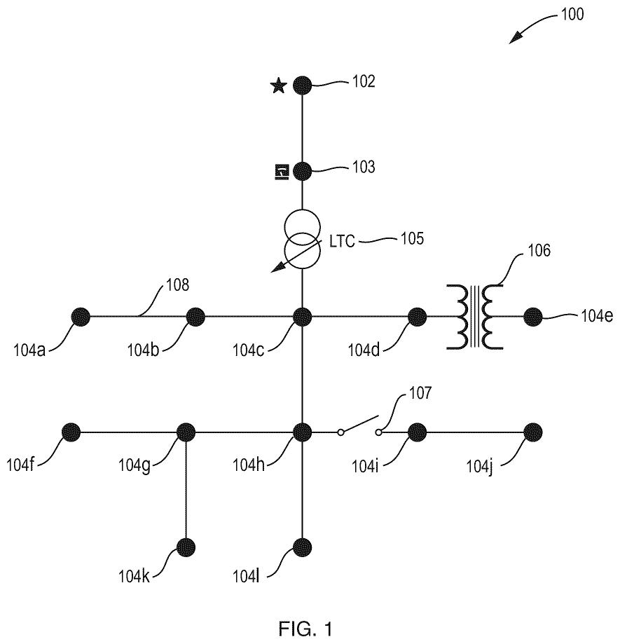

FIG. 1 is an example schematic diagram of an electrical system 100 that may be controlled and analyzed utilizing embodiments. The system 100 contains a source node 102, that is the voltage source for the system 100. The system 100 is an example electrical system modified from the IEEE 13 node test feeder [2], it should be understood that this system is an example system and embodiments may be employed to analyze and control any electrical systems. Located downstream from the source node 102 are a plurality of nodes, including a pseudo source node 103 and a plurality of nodes downstream nodes 104a-1. The nodes 102, 103 and 104a-1 may correspond to points in a real-world electrical system. For example, the nodes 102, 103, and 104a-1 may be substations or buses where a user is connected to the electrical network. In addition to the nodes 102, 103, and 104a-1, the system 100 also includes an on-load tap changing transformer (LTC) 105, transformer 106, and switch 107. It is noted that embodiments may be used to analyze electrical systems including any equipment and, the LTC 105, transformer 106, and switch 107 are non-limiting examples. Further still, the system 100 also includes edges, e.g., 108, connecting nodes. According to an embodiment, the edges, i.e., connecting line segments, may represent feeder line segments. Further, it is noted that in electrical systems, equipment, e.g., transformer 106, may be considered an edge, because the equipment connects nodes.

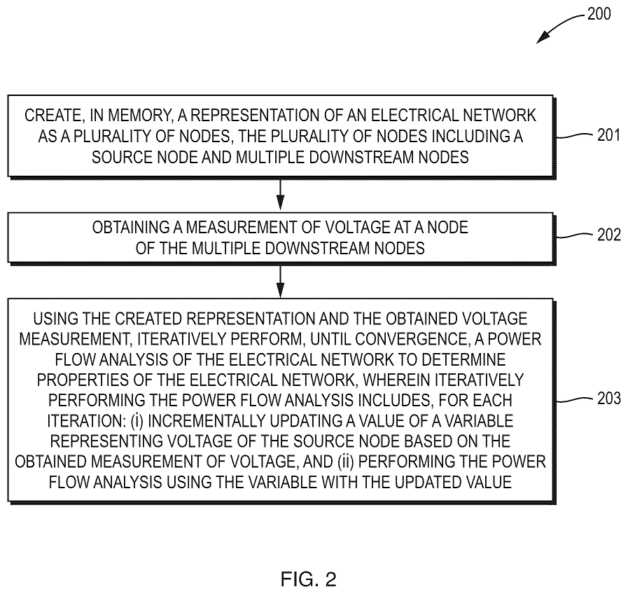

As described below at least in reference to method 200 of FIG. 2, the pseudo source node 103 is located within close proximity to the source node 102. Embodiments disclosed herein iteratively perform a power flow analysis, e.g., a distribution power flow analysis, to calculate a value for a variable representing the voltage of the source node 102 and update the value of the voltage variable until convergence. In an embodiment, convergence is achieved when a calculated value for voltage at the pseudo source node is approximately equal to a measured value of voltage at the pseudo source node in the real-world system.

FIG. 2 is a flowchart of a method 200 for determining properties of an electrical network, according to an embodiment. The method 200 begins at step 201 by creating, in a memory, a representation of the electrical network as a plurality of nodes. The plurality of nodes includes a source node, e.g., node 102 in FIG. 1, and multiple downstream nodes (i.e., nodes downstream from the source node), e.g., nodes 103 and 104a-1 of FIG. 1. At step 202, the method 200 obtains a measurement of voltage at a node of the multiple downstream nodes. To continue, at step 203, the representation (created at step 201) and the measurement of voltage (obtained at step 202) are used to iteratively perform, until convergence, a power flow analysis of the electrical network to determine properties of the electrical network. Iteratively performing the power flow analysis at step 203, includes, for each iteration, incrementally updating a value of a variable representing voltage of the source node based on the obtained measurement of voltage and performing the power flow analysis using the variable with the updated value. According to an embodiment, the power flow analysis may be performed using known techniques, but for the updates to the variable as described herein. Further, according to an embodiment, the power flow analysis performed at step 203, is a distribution power flow analysis.

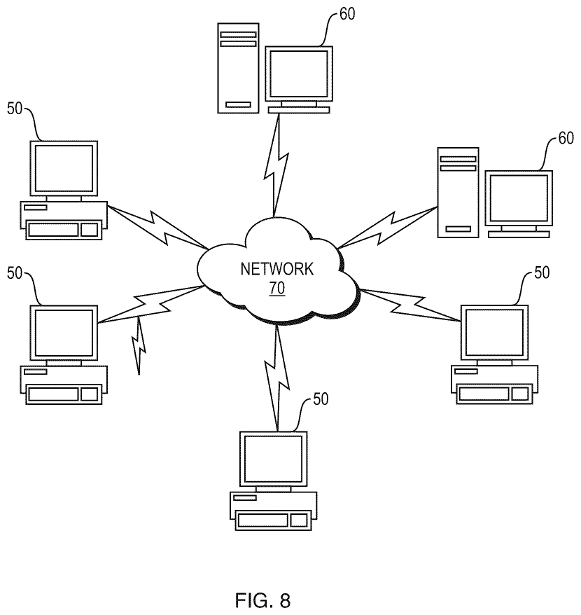

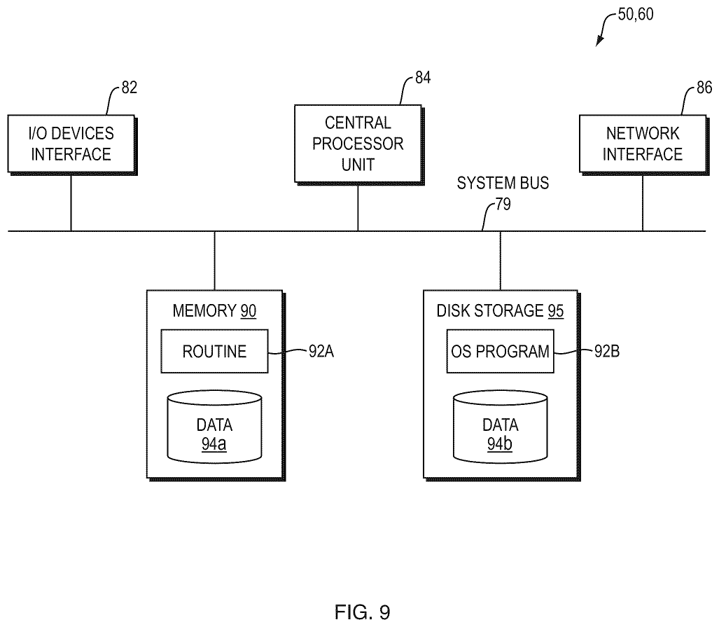

The method 200 is computer-implemented and, as such, the functionality and effective operations, e.g., the creating 201, obtaining 202, and performing 203 are automatically implemented by one or more digital processors. Moreover, the method 200 can be implemented using any computer device or combination of computing devices known in the art. Among other examples, the method 200 can be implemented using computer(s)/device(s) 50 and/or 60 described hereinbelow in relation to FIGS. 8 and 9.

At step 201, creating the representation may include obtaining/receiving properties of a subject electrical network and creating the representation based on the obtained properties. As described above, at step 201, the method 200 creates a representation of the electrical network as a plurality of nodes, in an embodiment, the method 200 also creates edges between the nodes. In such an embodiment, the representation is an abstraction of the electrical network in the form of a graph of nodes and branches. In this way, in such an embodiment, devices in an electrical network become either branch elements or terminal devices connected to the graph's nodes. Moreover, in an embodiment of the method 200, the representation may be created at step 201 in accordance with functionality known to those of skill in the art. The representation created at step 201 may represent a real-world electrical network, or a hypothetical electrical network being simulated.

As described above, at step 202, a measurement of voltage at a node of the multiple downstream nodes is obtained. This node of the multiple downstream nodes may be a pseudo source node, e.g., the pseudo source node 103 described hereinabove in relation to FIG. 1. Further, in embodiments, the source node may be located in relatively close proximity within the electrical network to the node of the multiple downstream nodes from which the measurement of voltage is obtained. Further, in embodiments, the measurement of voltage may be obtained at step 202 from any point that can be communicatively coupled to a computing device, e.g., processor, implementing the method 200. For instance, in an embodiment, obtaining the measurement of voltage at step 202 may include receiving the measurement from a sensor, e.g., voltage meter, at the node of the multiple downstream nodes.

According to an embodiment, at step 203, incrementally updating the value of the variable representing voltage of the source node based on the obtained measurement may include modifying the value of the voltage variable for the source node by adjusting a gain parameter of one or more functions. In another embodiment, incrementally updating the value of the variable representing voltage of the source node at step 203 includes, for a given iteration, calculating a given value of the variable, calculating an error value by determining a difference between the calculated given value of the variable and the obtained measurement of voltage at the node of the multiple downstream nodes, and updating the value of the variable using the calculated error value. In an embodiment of the method 200, convergence is reached when the error value is approximately equal to zero.

Further, according to another embodiment of the method 200, incrementally updating the value of the variable representing voltage of the source node based on the obtained measurement of voltage includes, in a given iteration, (i) determining an error signal based on a difference between the obtained measurement of voltage and a voltage at the node of the multiple downstream nodes determined by an iteration prior to the given iteration, (ii) processing the error signal with one or more functions to determine a given value of the variable, and (iii) setting the updated value of the variable to be the given value. In an embodiment, the error signal may be calculated using the following equation, eₖ=V_{PS}^{meas}−vₚₛ₍ₖ₎, where eₖ is the error signal, V_{PS}^{meas} is the measured voltage at the pseudo source node, and vₚₛ₍ₖ₎ is the calculated voltage of the pseudo source node. The iterative nature of step 203 results in step 203 being repeated until convergence. In an embodiment, convergence is reached when the error signal is calculated to be approximately equal to zero. This means that convergence is reached, according to an embodiment, when a calculated value for voltage at the node of the multiple nodes and the measured voltage are approximately the same. In other words, such an embodiment achieves convergence, when the calculated voltage of the pseudo source node and the measurement of voltage at the pseudo source node are approximately equal.

According to an embodiment, incrementally updating a value of the variable representing voltage of the source node at step 203 allows the power flow analysis to be performed using what is approximately the actual voltage at the source node in the real-world system and thereby provides a more accurate power flow analysis.

Embodiments of the method 200 may also be used to control the electrical system. For instance, one such embodiment controls operation of an element (e.g., switch, breaker, transformer, fuse, etc.) in the electrical network based on results of the power flow analysis performed at step 203. To illustrate, the power flow analysis at step 203 may determine that a branch power flow is too high and, in response, switching may be performed in the electrical network to balance power flow with a different feeder line.

An embodiment of the power flow solution integrates an adaptive feedback control mechanism to the power flow iteration loop. The control mechanism receives an error signal determined by comparing the measured voltage from the pseudo source node and calculated voltage at the pseudo source node, i.e., the node close to the source node, during each power flow iteration. This error is then used to influence and control the slack node's voltage at the start of the next power flow iteration. In an embodiment, the controller, i.e., the adaptive feedback control mechanism, has a gain or a constant that is adapted in each step based on how effective the control has been compared with the previous iteration.

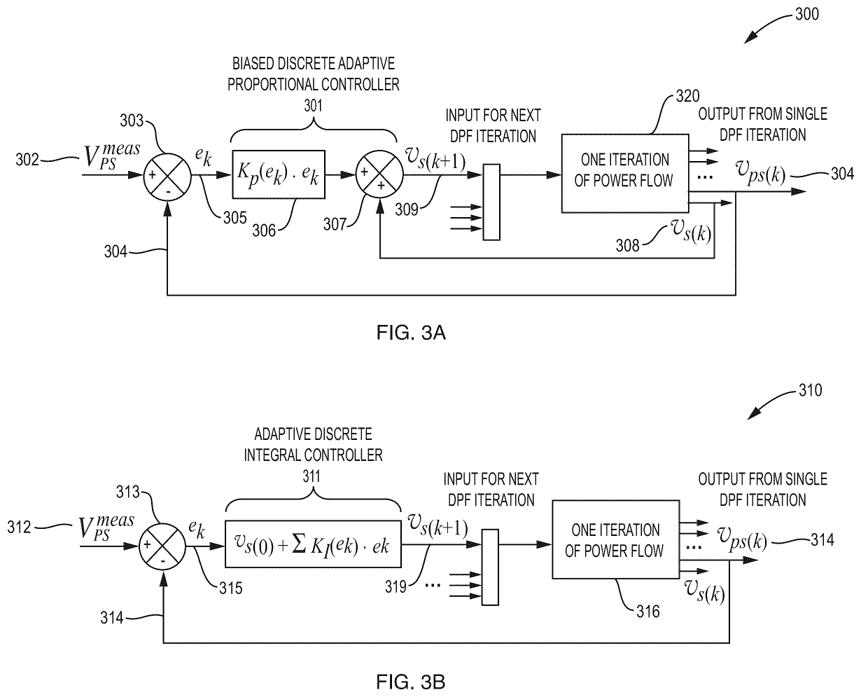

FIGS. 3A and 3B are schematic illustrations of adaptive feedback control methods that may be implemented in embodiments, e.g., at step 203 of the method 200.

FIG. 3A is a schematic illustration of an adaptive feedback control method 300 that employs a biased discrete adaptive controller 301. The method 300 begins by receiving measured voltage V_{PS}^{meas} 302 from the pseudo source node, i.e., a non-slack node close to the source node. This measured voltage 302 goes into a comparator 303 that determines the difference between the calculated voltage of the pseudo source node from the previous iteration vₚₛ₍ₖ₎ 304 and the measured voltage at the pseudo source node V_{PS}^{meas} 302. The difference determined by the comparator 303 is the error eₖ 305 based on results of the previous iteration (k). The error eₖ 305 determined based on results from the previous iteration goes into the controller 306 which processes the error eₖ 305 by multiplying the error eₖ 305 with a controller constant Kₚ(eₖ) as seen in Equation (1) below. The output of the controller 306 (i.e., the product of eₖ 305 and controller constant Kₚ(eₖ)) is then added 307 to the source voltage calculated from the previous iteration vₛ₍ₖ₎ 308 to determine the updated source voltage vₛ₍ₖ₊₁₎ 309 to use for the current iteration of power flow 320. As such, the output from the biased discrete adaptive proportional controller, vₛ₍ₖ₊₁₎ 309 is the input for the current power flow iteration 320.

FIG. 3B is a schematic illustration of an adaptive feedback control method 310 that employs an adaptive discrete integral controller 311. The method 310 begins by receiving measure voltage V_{PS}^{meas} 312 from the pseudo source node, i.e., a non-slack node close to the source node. This measured voltage 312 goes into a comparator 313 that determines the difference between the calculated voltage of the pseudo source node from the previous iteration vₚₛ₍ₖ₎ 314 and the measured voltage at the pseudo source node V_{PS}^{meas} 312. The difference determined by the comparator 313 is the error eₖ 315 determined from results of the previous iteration (k). The error eₖ 315 determined from results of the previous iteration is processed by the adaptive discrete integral controller 311 which processes the error 315 in accordance with Equation (2) below to determine the updated source voltage vₛ₍ₖ₊₁₎ 319. The output from the adaptive discrete integral controller, vₛ₍ₖ₊₁₎ 319 is the input for the current power flow iteration 316.

A further description of adaptive feedback control that may be utilized in embodiments is provided hereinbelow. To help illustrate the functionality, the description below is provided with reference to FIGS. 3A and 3B. According to an embodiment, V_{PS}^{meas} (302 and 312) represents the measured voltage of the pseudo slack node and vₚₛ₍ₖ₎ (304 and 314) represent the calculated voltage of the pseudo slack node at the previous iteration. Let eₖ (305 and 315) represent the error calculated from results of the previous iteration: eₖ=V_{PS}^{meas}−vₚₛ₍ₖ₎. For the next iteration (the iteration after the “previous iteration”), a biased discrete adaptive proportionate controller (301) can be used to determine the source voltage, vₛ₍ₖ₊₁₎ (309) as follows:

$${v}_{s ( k + 1 )} = {v}_{s ( k )} + {e}_{k} {K}_{p} ( {e}_{k} ) \qquad ( 1 )$$

where Kₚ(eₖ) is a proportional constant which is adapted based on its historical performance in decreasing errors. Equation (1) can also be written as an adaptive discrete integral controller (311) where an initial value of the integral control is set to the initial value of the slack node's voltage:

$${v}_{s ( k + 1 )} = {v}_{s ( 0 )} + {\sum }_{i = 0}^{k} {e}_{i} \cdot {K}_{p} ( {e}_{k} ) \qquad ( 2 )$$

It is noted embodiments can implement the controller independently for each phase in the power flow application, which will result in three controllers for each slack bus made up of three nodes.

As in most control applications, determining control parameters can be important to the effectiveness of the proposed control layer. An example embodiment utilizes classical Ybus equations to determine control inference.

To illustrate an embodiment, the power flow equation obtained by applying Kirchhoff's Current Law (KCL) at each node is given by:

$$Y V = I \qquad ( 3 )$$

where Y is the complex bus admittance matrix, V is the complex nodal voltage vector, and I is the complex nodal current injection. I is a function of the nodal voltage vector. If the nodal voltages are close to their rated value, as is usually the case, I can be approximated to be constant at any given snapshot of the system.

To continue, the matrices Y, V, and I can be turned into block matrices. Specifically,

$$Y = [ \begin{matrix}{Y}_{SS} & {Y}_{SL} \\ {Y}_{LS} & {Y}_{LL}\end{matrix} ] ,$$

Yss is the component of the Y matrix that corresponds to rows of the source nodes (3 source nodes in this case), while Y_{LL} is the component of the Y matrix that corresponds to the rows of the non-source nodes (3non-source nodes in this case).

$$V = [ \begin{matrix}{V}_{S} \\ {V}_{L}\end{matrix} ]$$

where V_{S} is the vector of nodal voltages for the slack bus and V_{L} is the vector of nodal voltages for the non-slack nodes. Similarly,

$$I = [ \begin{matrix}{I}_{S} \\ {I}_{L}\end{matrix} ] .$$

Using the matrices, Equation (3) becomes:

$$[ \begin{matrix}{Y}_{SS} & {Y}_{SL} \\ {Y}_{LS} & {Y}_{LL}\end{matrix} ] [ \begin{matrix}{V}_{S} \\ {V}_{L}\end{matrix} ] = [ \begin{matrix}{I}_{S} \\ {I}_{L}\end{matrix} ] \qquad ( 4 )$$

In traditional power flow, V_{S} is regarded as known. Solving for V_{L} gives:

$${V}_{L} = - {Y}_{LL}^{- 1} {Y}_{LS} {V}_{S} + {Y}_{LL}^{- 1} {I}_{L} \qquad ( 5 )$$

For a small change in V_{S} given by the vector ΔV_{S}, ignoring its effect on I_{L}, then

$${V}_{L} + {ΔV}_{L} ≅ - {Y}_{LL}^{- 1} {Y}_{LS} ( {V}_{S} + {ΔV}_{S} ) + {Y}_{LL}^{- 1} {I}_{L} \to {ΔV}_{L} ≅ - {Y}_{LL}^{- 1} {Y}_{LS} {ΔV}_{S} \qquad ( 6 )$$

To understand the nature of −Y_{LL}⁻¹Y_{LS} using a special case, for example set I_{L}=0 in Equation (5), and assume there are no shunt elements in the system, then −Y_{LL}⁻¹Y_{LS} must resolve to a column block matrix of identity matrix, such that

$${V}_{L} = [ \begin{matrix}{V}_{S} \\ {V}_{S} \\ … \\ {V}_{S}\end{matrix} ] .$$

This result is obtained by assuming there will be no voltage drop from slack nodes to the non-slack nodes. In this special case, Y is a special form of symmetric matrix in which elements in each row or column all sum to zero. This means that for any fixed Ybus matrix, a small change in source voltage, ΔV_{S}, will result in an approximately equal change in non-source voltage. Consequently, Equation (6) can be rewritten as:

$${ΔV}_{L} ≅ [ \begin{matrix}{ΔV}_{S} \\ {ΔV}_{S} \\ … \\ {ΔV}_{S}\end{matrix} ] \qquad ( 7 )$$

Equation (7) is only an approximation because the Ybus often includes shunt elements and the nodal current injections are sometimes dependent on the nodal voltage. From Equation (7), given the approximate proportionate influence of the source voltage on other nodal voltages, it is possible to control the source voltage to realize a given voltage at any node using a feedback control approach, e.g., the methods 300 and 310 described hereinabove. Equation (7) also gives an idea of a good gain to apply to the error signal when implementing such control methods, namely a gain of ≅1. Control gains greater than 1 can easily lead to oscillations and prevent and/or delay power flow convergence.

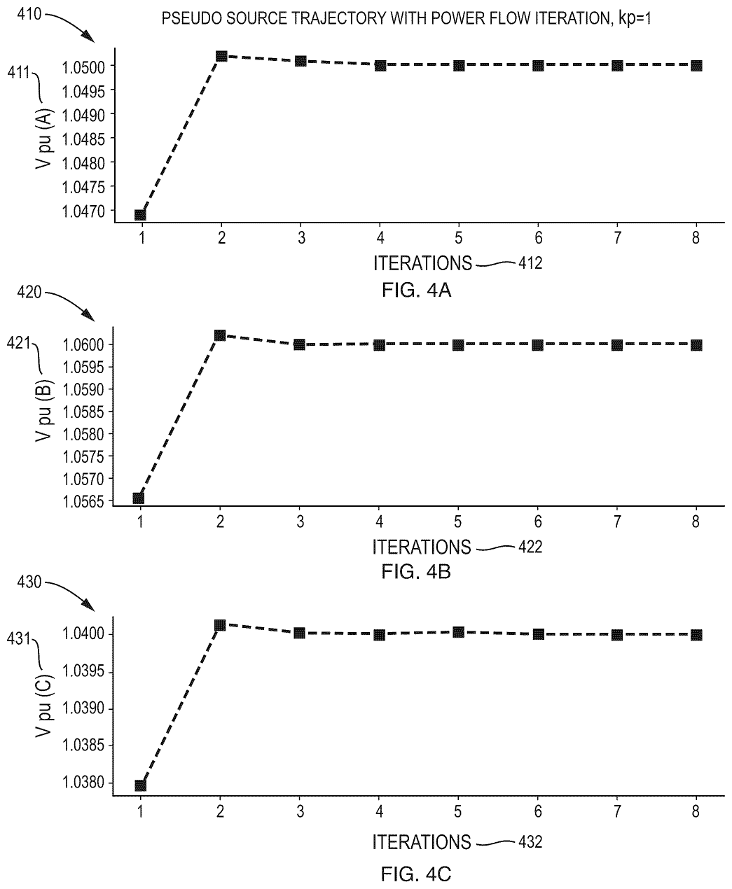

FIGS. 4A-C, 5A-C, and 6A-C are sample responses for different control gains applied to a prototype implementation and sample data realized from a modified IEEE 13 node test feeder [2]. In line with the control inference, FIGS. 4A-C, 5A-C, and 6A-C shown that a control gain of 1 had the best response and got the pseudo source voltages close to their solution voltage within just one iteration. To obtain the results shown in FIGS. 4A-C, 5A-C, and 6A-C, the nodal voltages were initially set with flat start voltages of 1 per unit (p.u.) at 0^{th} iteration and a plot of the 0^{th} iteration has been omitted to zoom in on the voltages from the 1^{st} iteration onwards.

FIGS. 4A-4C are graphs 410, 420, and 430, respectively, of pseudo source voltage 411, 421, and 431, determined using power flow implemented according to an embodiment with a control gain parameter of Kₚ=1, versus iterations 412, 422, and 432. Graph 410 shows the pseudo source voltage trajectory 411 versus power flow iterations 412 for phase A. Graph 420 shows the pseudo source voltage trajectory 421 versus power flow iterations 422 for phase B. Graph 430 shows the pseudo source voltage trajectory 431 versus power flow iterations 432 for phase C.

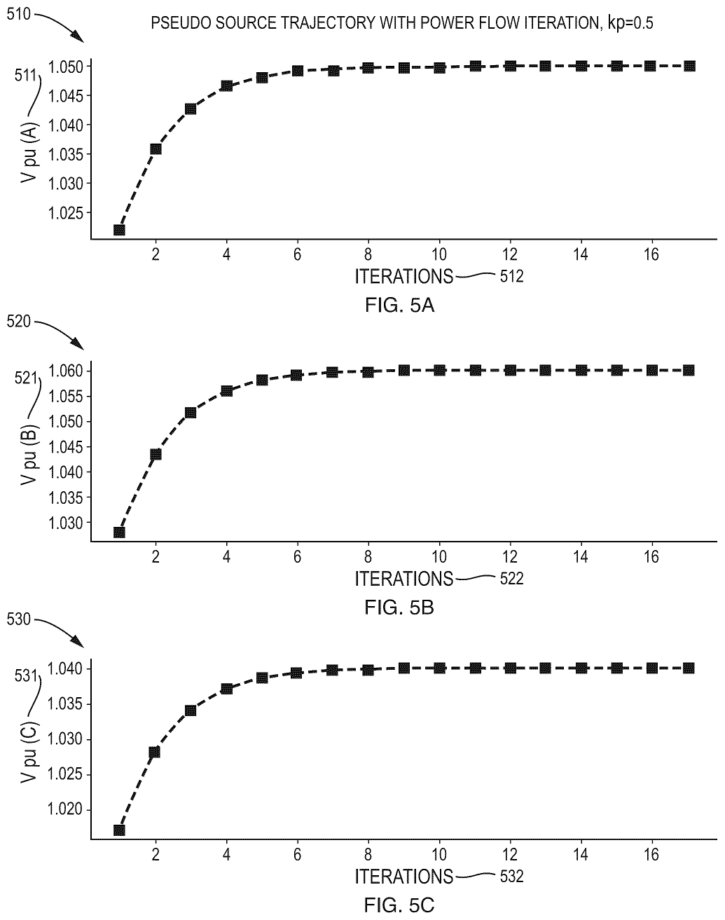

FIGS. 5A-5C are graphs 510, 520, and 530, respectively, of pseudo source voltage 511, 521, and 531, determined using power flow implemented according to an embodiment with a control gain parameter of Kₚ=0.5, versus iterations 512, 522, and 532. Graph 510 shows the pseudo source voltage trajectory 511 versus power flow iterations 512 for phase A. Graph 520 shows the pseudo source voltage trajectory 521 versus power flow iterations 522 for phase B. Graph 530 shows the pseudo source voltage trajectory 531 versus power flow iterations 532 for phase C.

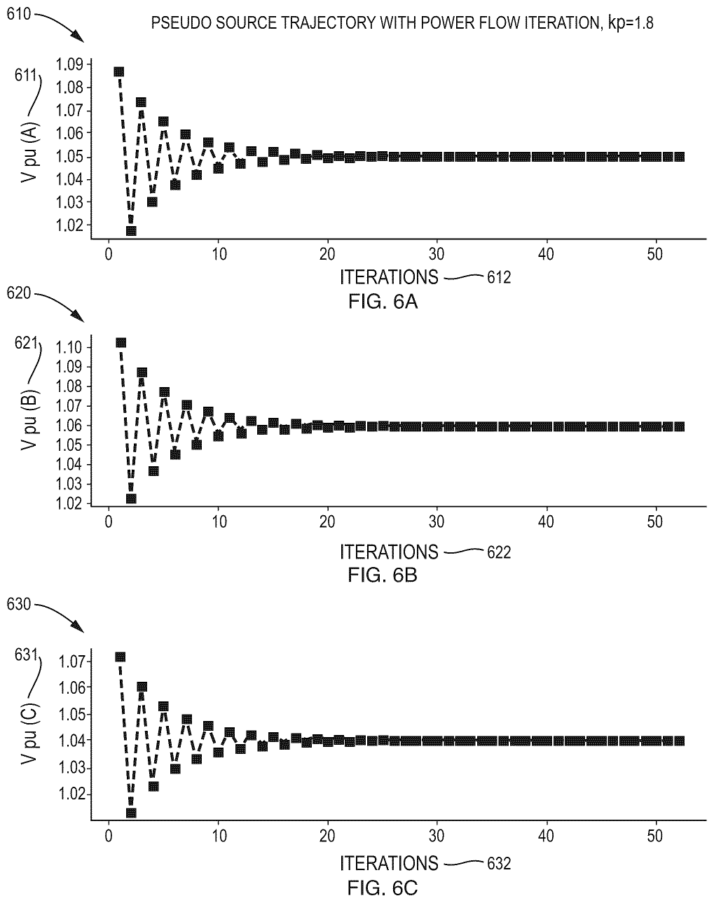

FIGS. 6A-6C are graphs 611, 621, and 631, respectively, of pseudo source voltage 611, 621, and 631, determined using power flow implemented according to an embodiment with a control gain parameter of Kₚ=1.8, versus iterations 612, 622, and 632. Graph 610 shows the pseudo source voltage trajectory 611 versus power flow iterations 612 for phase A. Graph 620 shows the pseudo source voltage trajectory 621 versus power flow iterations 622 for phase B. Graph 630 shows the pseudo source voltage trajectory 631 versus iterations 632 for phase C.

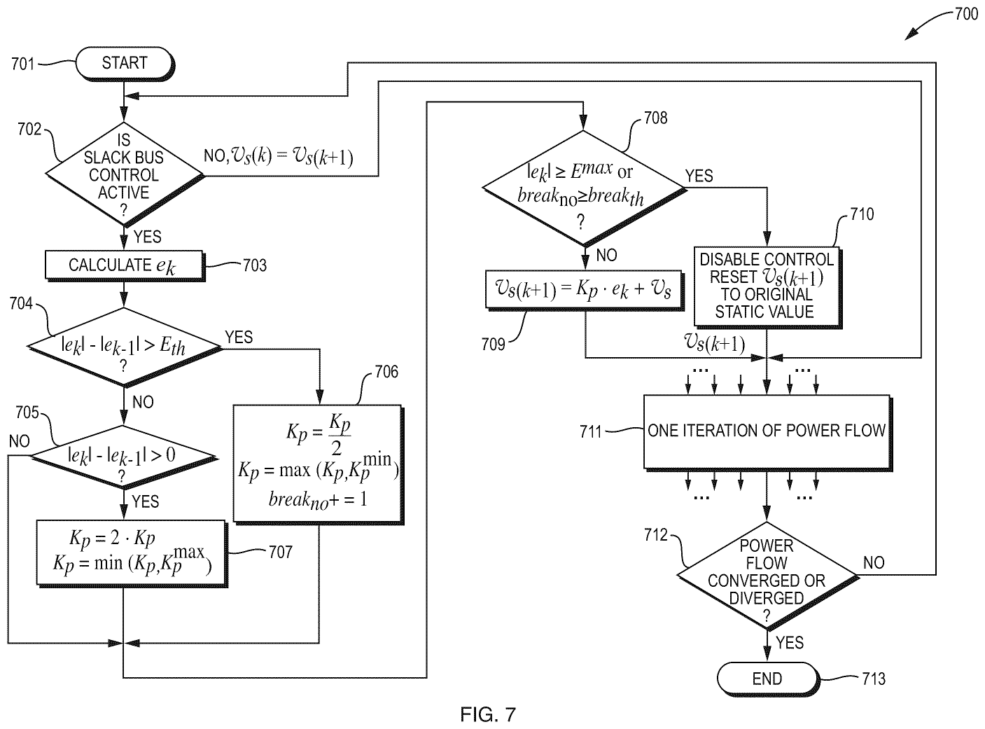

Hereinbelow, the mechanism of a controller according to an embodiment is described. In such an embodiment, for each source bus, three controllers are instantiated for each of the source bus's three nodes/phases in DPF. The controller gain, Kₚ, is adjusted in each iteration depending on how effective the controller has been. According to an embodiment, effectiveness of the controller is based independently on current and previous error values for each phase. The adjustment methodology, according to an embodiment, is shown in FIG. 7 discussed below. Kₚ is bound by Kₚ^{min} and Kₚ^{max}, and is decreased or increased depending on whether the absolute error is increasing or decreasing, respectively, when compared with the error from a previous iteration. Depending on the unit of voltage used to calculate the error, certain large absolute errors indicate the infiltration of a bad voltage measurement. In such a case, the control may be disabled. Also, the number of times the control is not effective in decreasing the error may be used as an exit condition for disabling the control and implementing conventional power flow techniques.

FIG. 7 is a flow diagram of a method 700 for analyzing an electrical network while adjusting a controller constant according to an embodiment. The method 700 starts 701 and, in turn, at step 702, the method 700 determines if slack bus control is active. Responsive to the slack bus control not being active, i.e., vₛ(k)=vₛ₍ₖ₊₁₎, the method 700 moves to step 711 where a source voltage of vₛ₍ₖ₊₁₎ is used in the next iteration of power flow. Responsive to the slack bus control being active, i.e., yes at step 702, the method 700 moves to step 703 and calculates the error value (eₖ) for the current (k^{th}) iteration. Next, at step 704, the method 700 checks if the change in error exceeds the error change threshold Eₜₕ(|eₖ|−|eₖ₋₁>Eₜₕ). In other words, at step 704, the method 700 evaluates if the difference between the error at the current iteration and the error at the previous iteration exceeds a threshold. If the error change is greater than the change threshold Eₜₕ, i.e., the answer at step 704 is “Yes,” then the method 700 determines controller gain Kₚ at step 706 using the following equations:

$${K}_{p} = \frac{{K}_{p}}{2} where {K}_{p} = max ( {K}_{p} , {K}_{p}^{min} ) , {break}_{no} += 1 ,$$

where Kₚ is the controller constant, Kₚ^{min} is the minimum controller constant and breakₙₒ is the number of times the error change threshold is broken, i.e., there is an ineffective error decrease in current iteration compared to the previous iteration. The output of step 706 then becomes part of the input to step 708, discussed below.

Still referring to FIG. 7, if at step 704 it is determined that the change in error change is less than the change threshold Eₜₕ, i.e., the answer at step 704 is “No,” then the method 700 checks at step 705 if the change in error between the current iteration and previous iteration is less than zero (|eₖ|−|eₖ₋₁<0). If the change in error between the current iteration and previous iteration is less than zero, i.e., the answer at step 705 is “Yes,” the method 700 then determines controller gain Kₚ, at step 707 using the following equations: Kₚ=2×Kₚ where Kₚ=min(Kₚ, Kₚ^{max}) where Kₚ is the controller constant, Kₚ^{max} is the maximum controller constant. After step 707, the method 700 moves to step 708. Likewise, if the change in error between the current iteration and previous iteration is larger than zero, i.e., the answer at step 705 is “No,” the method 700 also moves to step 708.

At step 708 the method 700 checks if the error at the current iteration (eₖ) is larger than or equal to the maximum absolute error (E^{max}) or if the breakₙₒ, i.e., the number of times the error change threshold is broken (representing an ineffective error decrease in the current iteration compared to the previous iteration), is larger than or equal to the threshold for breakₙₒ (breakₜₕ). Responsive to the error at the current iteration being larger than or equal to the maximum absolute error, or the breakₙₒ being larger than or equal to the threshold breakₜₕ, i.e., the answer at step 708 being “Yes,” the method 700 moves to step 710 and disables source voltage control and resets vₛ₍ₖ₊₁₎ to the original static value. The output of step 710, i.e., vₛ₍ₖ₊₁₎ is then used at step 711 for the next iteration of power flow. Returning to step 708, if the error at the current iteration is not larger than or equal to the maximum absolute error and the breakₙₒ is not larger than or equal to the threshold breakₜₕ, i.e., the answer at step 708 is “No,” the method 700 moves to step 709 and updates the source voltage vₛ₍ₖ₊₁₎ using the following equation: vₛ₍ₖ₊₁₎=Kₚ×eₖ+vₛ. The updated vₛ₍ₖ₊₁₎ is then used at step 711 for the next iteration of power flow. At step 711 the method 700 performs an iteration of a power flow analysis and determines properties of the electrical network, e.g., voltages at nodes in the network. Based on results of performing the power flow analysis, at step 712, the method 700 determines if the power flow analysis has converged or diverged. If the power flow analysis converged, i.e., “Yes” at step 712, the method 700 “Ends” at step 713. If the power flow analysis has not converged or the power flow analysis has diverged, i.e., “No” at step 712, the method 700 returns to step 702 and the method 700 repeats.

FIG. 8 illustrates a computer network or similar digital processing environment in which embodiments of the present disclosure may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

FIG. 9 is a diagram of an example internal structure of a computer (e.g., client processor/device 50 or server computers 60) in the computer system of FIG. 8. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 8). Memory 90 provides volatile storage for computer software instructions 92A and data 94a used to implement an embodiment of the present disclosure. The computer software instructions can implement the methods and operations of the methods described herein, e.g., the methods 200, 300, 310, and/or 700 detailed above. Disk storage 95 provides non-volatile storage for computer software instructions 92B and data 94b used to implement an embodiment of the present disclosure. The computer software instructions can implement the methods and operations of methods detailed herein. A central processor unit 84 is also attached to the system bus 79 and provides for the execution of computer instructions.

In one embodiment, the processor routines 92A-B and data 94a-b are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for an embodiment. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92A-B.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus, the data processors described herein are intended for purposes of illustration only and not as a limitation of the embodiments.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

### REFERENCES

[1] G. W. Chang, S. Y. Chu, and H. L. Wang, “An Improved Backward/Forward Sweep Load Flow Algorithm for Radial Distribution Systems,” in IEEE Transactions on Power Systems, vol. 22, no. 2, pp. 882-884, May 2007, doi: 10.1109/TPWRS.2007.894848.
[2] K. P. Schneider, B. A. Mather, B. C. Pal, C. W. Ten, G. J. Shirek, H. Zhu, J. C. Fuller, J. L. R. Pereira, L. F. Ochoa, L. R. de Araujo, R. C. Dugan, S. Matthias, S. Paudyal, T. E. McDermott, and W Kersting, “Analytic Considerations and Design Basis for the IEEE Distribution Test Feeders,” IEEE Transactions on Power Systems, vol. PP, no. 99, pp. 1-1, 2017.

What is claimed is:

1. A computer-implemented method for determining properties of an electrical network, the method comprising, by a processor:
creating, in memory, a representation of the electrical network as a plurality of nodes, the plurality of nodes including a source node and multiple downstream nodes;
obtaining a measurement of voltage at a node of the multiple downstream nodes; and
using the created representation and the obtained measurement of voltage, iteratively performing, until convergence, a power flow analysis of the electrical network to determine the properties of the electrical network, wherein iteratively performing the power flow analysis includes, for each iteration: (i) incrementally updating a value of a variable representing voltage of the source node based on the obtained measurement of voltage, and (ii) performing the power flow analysis using the variable with the updated value.

2. The computer-implemented method of claim 1, wherein incrementally updating the value of the variable representing voltage of the source node comprises, in a given iteration:
calculating a given value of the variable;
calculating an error value by determining a difference between the calculated given value of the variable and the obtained measurement of voltage at the node of the multiple downstream nodes; and
updating the value of the variable using the error calculated.

3. The computer-implemented method of claim 2, further comprising:
responsive to the error value being approximately equal to zero, determining convergence is reached.

4. The computer-implemented method of claim 1, wherein incrementally updating the value of the variable representing voltage of the source node based on the obtained measurement of voltage comprises, in a given iteration:
determining an error signal based on the obtained measurement of voltage and a voltage at the node of the multiple downstream nodes determined by an iteration prior to the given iteration;
processing the error signal with one or more functions to determine a given value of the variable; and
setting the updated value of the variable to be the given value.

5. The computer-implemented method of claim 1, wherein the source node is located in relative close proximity within the electrical network to the node of the multiple downstream nodes from which the measurement of voltage is obtained.

6. The computer-implemented method of claim 1, wherein obtaining the measurement of voltage at the node of the multiple downstream nodes comprises:
receiving the measurement from a voltage meter at the node of the multiple downstream nodes.

7. The computer-implemented method of claim 1, wherein incrementally updating the value of the variable representing voltage of the source node based on the obtained measurement of voltage comprises:
modifying the value of the voltage variable for the source node by adjusting a gain parameter of one or more functions.

8. The computer-implemented method of claim 1, further comprising:
based on results of the performing the power flow analysis, controlling operation of an element in the electrical network.

9. A computer-based system for determining properties of an electrical network, the system comprising:
a processor; and
a memory with computer code instructions stored thereon, the processor and the memory, with the computer code instructions, being configured to cause the system to:
create, in the memory, a representation of the electrical network as a plurality of nodes, the plurality of nodes including a source node and multiple downstream nodes;
obtain a measurement of voltage at a node of the multiple downstream nodes; and
using the created representation and the obtained measurement of voltage, iteratively perform, until convergence, a power flow analysis of the electrical network to determine the properties of the electrical network, wherein iteratively performing the power flow analysis includes, for each iteration: (i) incrementally updating a value of a variable representing voltage of the source node based on the obtained measurement of voltage, and (ii) performing the power flow analysis using the variable with the updated value.

10. The computer-based system of claim 9, wherein, in incrementally updating the value of the variable representing voltage of the source node, the processor and the memory, with the computer code instructions, are configured to cause the system to, in a given iteration:
calculate a given value of the variable;
calculate an error value by determining a difference between the calculated given value of the variable and the obtained measurement of voltage at the node of the multiple downstream nodes; and
update the value of the variable using the error calculated.

11. The computer-based system of claim 10, wherein the processor and the memory, with the computer code instructions, are further configured to cause the system to:
responsive to the error value being approximately equal to zero, determine convergence is reached.

12. The computer-based system of claim 9, wherein, in incrementally updating the value of the variable representing voltage of the source node based on the obtained measurement of voltage, the processor and the memory, with the computer code instructions, are configured to cause the system to, in a given iteration:
determine an error signal based on the obtained measurement of voltage and a voltage at the node of the multiple downstream nodes determined by an iteration prior to the given iteration;
process the error signal with one or more functions to determine a given value of the variable; and
set the updated value of the variable to be the given value.

13. The computer-based system of claim 9, wherein the source node is located in relative close proximity within the electrical network to the node of the multiple downstream nodes from which the measurement of voltage is obtained.

14. The computer-based system of claim 9, wherein, in obtaining the measurement of voltage at the node of the multiple downstream nodes, the processor and the memory, with the computer code instructions, are configured to cause the system to:
receive the measurement from a voltage meter at the node of the multiple downstream nodes.

15. The computer-based system of claim 9, wherein, in incrementally updating the value of the variable representing voltage of the source node based on the obtained measurement of voltage, the processor and the memory, with the computer code instructions, are configured to cause the system to:
modify the value of the voltage variable for the source node by adjusting a gain parameter of one or more functions.

16. The computer-based system of claim 9, wherein, the processor and the memory, with the computer code instructions, are further configured to cause the system to:
based on results of the performing the power flow analysis, control operation of an element in the electrical network.

17. A computer program product for determining properties of an electrical network, the computer program product comprising a non-transitory computer-readable medium with computer code instructions stored thereon, the computer code instructions, when executed by a processor, cause an apparatus associated with the processor to:
create, in memory, a representation of the electrical network as a plurality of nodes, the plurality of nodes including a source node and multiple downstream nodes;
obtain a measurement of voltage at a node of the multiple downstream nodes; and
using the created representation and the obtained measurement of voltage, iteratively perform, until convergence, a power flow analysis of the electrical network to determine the properties of the electrical network, wherein iteratively performing the power flow analysis includes, for each iteration: (i) incrementally updating a value of a variable representing voltage of the source node based on the obtained measurement of voltage, and (ii) performing the power flow analysis using the variable with the updated value.

18. The computer program product of claim 17, wherein, in incrementally updating the value of the variable representing voltage of the source node, the computer code instructions, when executed by the processor, cause the apparatus associated with the processor to:
calculate a given value of the variable;
calculate an error value by determining a difference between the calculated given value of the variable and the obtained measurement of voltage at the node of the multiple downstream nodes; and
update the value of the variable using the error calculated.

19. The computer program product of claim 17, wherein, in incrementally updating the value of the variable representing voltage of the source node based on the obtained measurement of voltage, the computer code instructions, when executed by the processor, cause the apparatus associated with the processor to:
determine an error signal based on the obtained measurement of voltage and a voltage at the node of the multiple downstream nodes determined by an iteration prior to the given iteration;
process the error signal with one or more functions to determine a given value of the variable; and
set the updated value of the variable to be the given value.

20. The computer program product of claim 17, wherein, in incrementally updating the value of the variable representing voltage of the source node based on the obtained measurement of voltage, the computer code instructions, when executed by the processor, cause the apparatus associated with the processor to:
modify the value of the voltage variable for the source node by adjusting a gain parameter of one or more functions.
